(19) United States
(12) Patent Application Publication
(10) Pub. No.: US 2015/0271890 A1
(43) Pub. Date: Sep. 24, 2015

(54) LEDs Any Color

(71) Applicant: Rodney L. Bates, Mountain House, CA (US)

(72) Inventor: Rodney L. Bates, Mountain House, CA (US)

(21) Appl. No.: 14/222,662

(22) Filed: Mar. 23, 2014

(51) Int. Cl. H05B 33/08

(52) U.S. Cl. CPC H05B 33/0863; H05B 33/0845

(57) ABSTRACT

Light Emitting Diodes (LEDs) are tiny light bulbs commonly used in flashlights today. Commercial and consumer applications require the creation of specified colors of light. Other methods of creating a specified color of LED light involve the use of 3, 4, 5, or more LEDs. This invention uses only 2 LEDs, chosen from a set of 6 LEDs, to create a specified visible color.

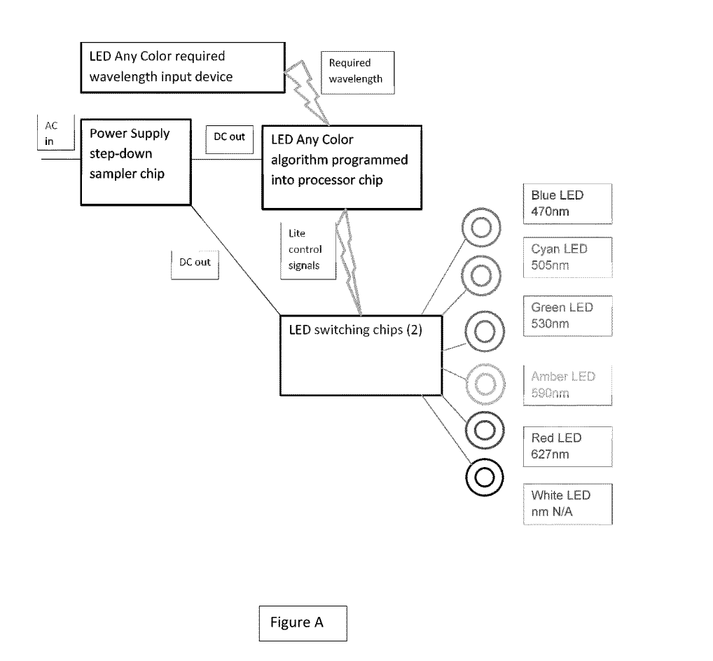

### TECHNICAL FIELD AND INDUSTRIAL APPLICABILITY OF THE INVENTION

This invention relates to creating a true-color light by utilizing only 2 Light Emitting Diodes. The resulting light is measured as scientifically accurate.

### BACKGROUND OF THE INVENTION

Light Emitting Diodes (LEDs) have been used for engineering and scientific purposes since 1962. During the 1990's wide-spread commercial and consumer use of LEDs began.

Commercial and consumer applications for LEDs can require the generation of multiple colors from one LED fixture. Since each LED can produce only a specified color range, the light from multiple LEDs, properly blended, is used to produce the desired color. Until 2002, 5 LEDs were used to produce a specified color. More recently, 3 LEDs are blended to produce the specified color.

This invention is the next step in the evolution of LED lighting. Given 6 LEDs, and a complex control circuit, only 2 LEDs need to be lit to produce a specified color.

### SPECIFICATION

### Description

This invention consists of a circuit that performs the function of controlling one or more sets of 6 LEDs to produce a specified color. Only 2 of the LEDs in each set are lit. The LEDs produce a true color. It is not a “fool the human eye” color. The color is measured in nanometers

Parts and Functionality (see Figure A):

a. Power to the switch circuit is 110 volts, supplied to a step-down sampler chip. The step-down sampler chip supplies power to the LEDs and the LEDs Any Color control circuit.

b. Color selection input to the LEDs Any Color control circuit can be provided by a DMX theatre console, red and blue buttons, a slider, or a knob. Digital color selection input can be provided by a simple digital data entry device.

c. The LEDs Any Color control circuit algorithm, programmed into the LEDs Any Color control circuit processor chip compares the required wavelength of light to the specifications of the 6 LEDs available.

d. The LEDs Any Color control circuit processor chip selects 2 of the LEDs in each set to switch on. Each of the two LEDs is assigned an intensity from 1 to 100. The other 4 LEDs have an intensity of zero assigned.

e. Signals are passed to the LEDs Any Color control circuit switching chips, which directly control the LEDs. 2 LEDs in each set of 6 LEDs will receive voltage to switch on, proportional to the assigned intensities. 4 LEDs in each set of 6 LEDs will receive no voltage, and therefore switch off.

f. 2 LEDs from each set of 6 LEDs light up, with the intensity specified by the LEDs Any Color control circuit switching chips.

g. The light from the two LEDs is blended, using a lens. The resultant blended light has the wavelength required.

Parts and Functionality (see Figure A) (Continued)

h. The 6 required LEDs are as follows:
i. BLUE: 470 nm
ii. CYAN: 505 nm
iii. GREEN: 530 nm
iv. AMBER: 590 nm
v. RED: 627 nm
vi. WHITE: (N/A)

i. Multiple sets of 6 LEDs can be used to create a greater intensity of light.

Best way to practice the invention: build a circuit comprising a digital input device, AC power supply, wires, processor chip with algorithm, LED switching chips, light biscuit, lens, and the 6 required LEDs of approximately the same wattage.

Although the present invention has been described with reference to preferred embodiments, numerous modifications and variations can be made and still fall within the scope of the invention.

Increasing or decreasing the scale of the preferred embodiment and/or increasing the number of instances of the embodiment will still fall within the scope of the invention.

1: LEDs Any Color control circuit is achieved by constructing a lighting circuit comprising:
a. Required wavelength input device.
b. One DC power supply step-down sampler chip,
c. LEDs Any Color control circuit processor micro-computer chip,
d. LEDs Any Color control circuit algorithm, which is programmed into the LEDs Any Color control circuit processor micro-computer chip,
e. LEDs Any Color control circuit switching chips.
f. The 6 required LEDs are as follows:
i. BLUE: 470 nm
ii. CYAN: 505 nm
iii. GREEN: 530 nm
iv. AMBER: 590 nm
v. RED: 627 nm
vi. WHITE: (N/A)

2: Based on the LEDs Any Color control circuit from claim 1, different types of devices can be used to input the wavelength of the light required.

3: Based on the LEDs Any Color control circuit from claim 1, the LEDs Any Color control circuit processor chip selects 2 of the LEDs assigned intensity from 1 to 100.

4: Based on the LEDs Any Color control circuit from claim 1, the LEDs Any Color control circuit switching chips will send DC current to 2 LEDs in each set of 6 LEDs.

5: Based on the LEDs Any Color control circuit from claim 1, 2 LEDs from the set of 6 LEDs will generate light.

6: Based on the LEDs Any Color control circuit from claim 1, a lens blends the light from the 2 LEDs to produce the required wavelength of light.

7: Based on the LEDs Any Color control circuit from claim 1, when a greater amount of LEDs Any Color lighting is required, multiple sets of LEDs are used.

8: Based on the LEDs Any Color control circuit from claim 1, when a lesser amount of LEDs Any Color lighting is required, smaller LEDs are used.

9: Based on the LEDs Any Color control circuit from claim 1, although the present invention has been described with reference to preferred embodiments, numerous modifications and variations can be made and still fall within the scope of the invention.

10: Based on the LEDs Any Color control circuit from claim 1, increasing or decreasing the scale of the preferred embodiment and/or increasing the number of instances of the embodiment will still fall within the scope of the invention.
